(19) United States
(12) Patent Application Publication
(10) Pub. No.: US 2013/0235615 A1
(43) Pub. Date: Sep. 12, 2013

(54) LIGHT GUIDE PLATE AND BACKLIGHT MODULE USING SAME

(71) Applicant: LI-YING WANG HE, Tu-Cheng (TW)

(72) Inventor: LI-YING WANG HE, Tu-Cheng (TW)

(73) Assignee: HON HAI PRECISION INDUSTRY CO., LTD., Tu-Cheng (TW)

(21) Appl. No.: 13/556,225

(22) Filed: Jul. 24, 2012

(30) Foreign Application Priority Data
Mar. 6, 2012 (TW) 101107428

(51) Int. Cl. F21V 7/04; F21V 8/00

(52) U.S. Cl. 362/609; 362/621; 362/613

(57) ABSTRACT

A light guide plate includes a main body and a number of semi-cylindrical shaped protrusions. The main body includes a light incident surface and a top surface perpendicular to the light incident surface. The top surface includes a light emitting area and a fringe area surrounding the light emitting area. The protrusions are continuously distributed on the light incident surface. Each protrusion includes two semicircular end surfaces opposite to each other, a plane fixed surface fixed on the light incident surface, and an arc-shaped peripheral surface. The diameter of the end surfaces is less than 1 millimeter. The length of each protrusion along its central axis is substantially equal to the thickness of the light incident surface along a direction perpendicular to the top surface.

### BACKGROUND

1. Technical Field

The present disclosure relates to a light guide plate and a backlight module using the light guide plate.

2. Description of Related Art

Backlight modules often include a light guide plate and a number of spaced light sources. The light guide plate includes a light incident surface and a top surface perpendicular to the light incident surface. The top surface includes an effective light emitting surface at a central portion thereof. The light sources are positioned adjacent to the light incident surface. Dark areas are formed between the spaced light sources because the light rays from the light sources cannot properly light the spaces, therefore, the brightness of the light incident surface is not uniform, additionally, without a defined microstructure in the light incident surface, even though the light rays from the light sources pass through the light guide plate, the brightness of the light emitting area is also not uniform.

Therefore, it is desirable to provide a light guide plate and a backlight module that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a backlight module, according to an exemplary embodiment, the backlight module including a light guide plate.

FIG. 2 is a schematic view of the light guide plate of FIG. 1, the light guide plate including a number of protrusions.

FIG. 3 is a schematic view of each of the protrusions of FIG. 2.

### DETAILED DESCRIPTION

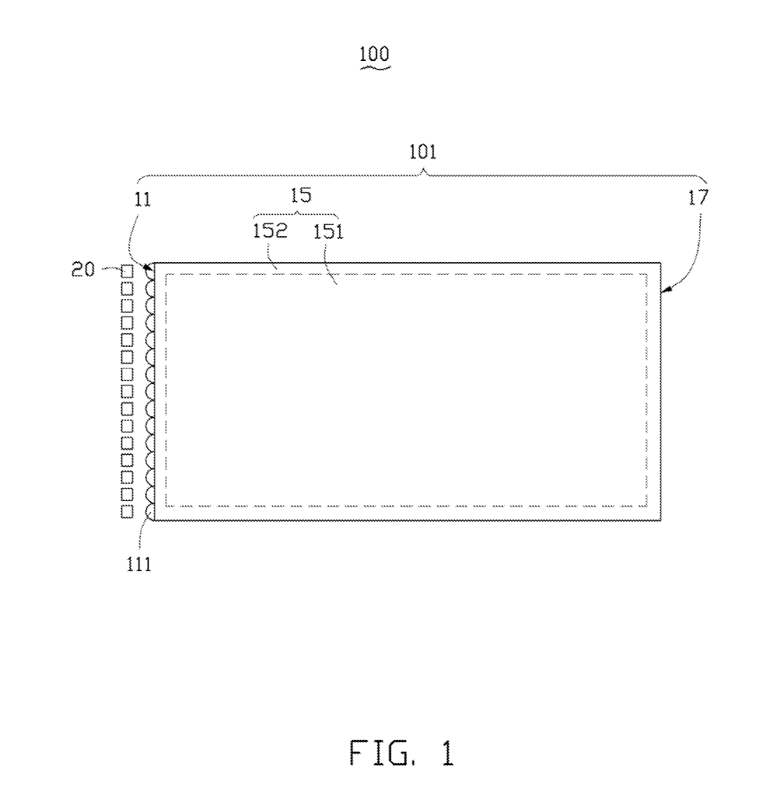

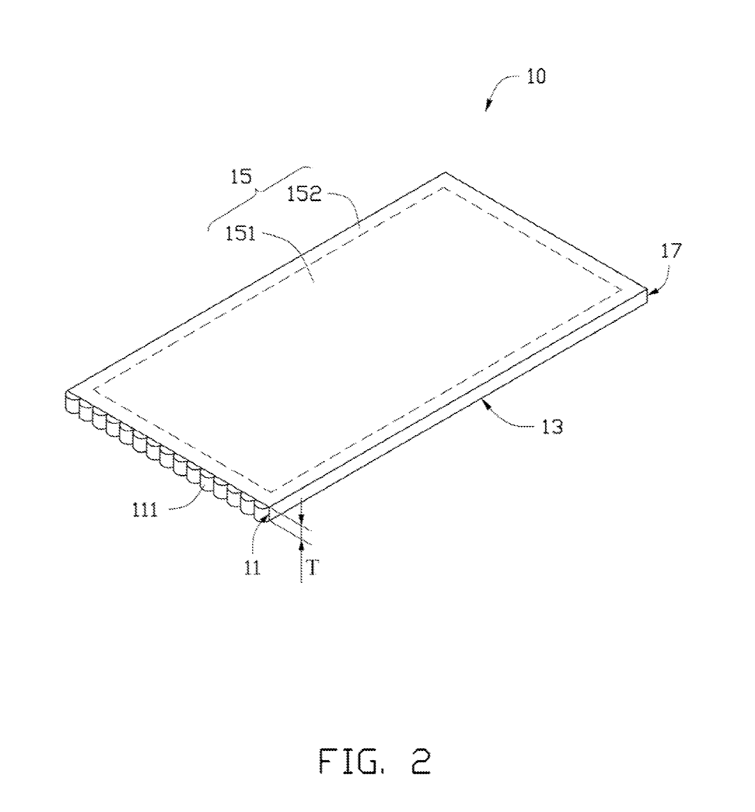

Referring to FIGS. 1-2, a backlight module 100, according to an embodiment, includes a light guide plate 10 and a number of light sources 20. In this embodiment, the light sources 20 are light emitting diodes (LEDs).

The light guide plate 10 is made of transparent material (such as acrylic resin or polyethylene resin), and includes a main body 101 and a number of semi-cylindrical protrusions 111. In this embodiment, the main body 101 and the protrusions 111 are integrally formed.

The main body 101 includes a light incident surface 11, a bottom surface 13, a top surface 15, and a side surface 17. The bottom surface 13 is substantially parallel to the top surface 15. The light incident surface 11 is connected to the top surface 15 and the bottom surface 13. The light incident surface 11 is substantially perpendicular to the top surface 15. The side surface 17 is connected to the top surface 15 and the bottom surface 13, and is at an opposite side of the light guide plate 10 to the light incident surface 11. In other embodiments, the bottom surface 13 can be inclined with respect to the top surface 15.

The top surface 15 includes a light emitting area 151 (indicated by broken line) and a fringe area 152 surrounding the light emitting area 151.

The light sources 20 face the light incident surface 11. The light incident surface 11 transmits light rays from the light sources 20 into the light guide plate 10. The bottom surface 13 and the side surface 17 respectively internally reflect the light rays in the light guide plate 10. The light emitting area 151 transmits a portion of the light rays incident thereon to the exterior above the light guide plate 10, and reflects the other portion of the light rays incident thereon back into the light guide plate 10.

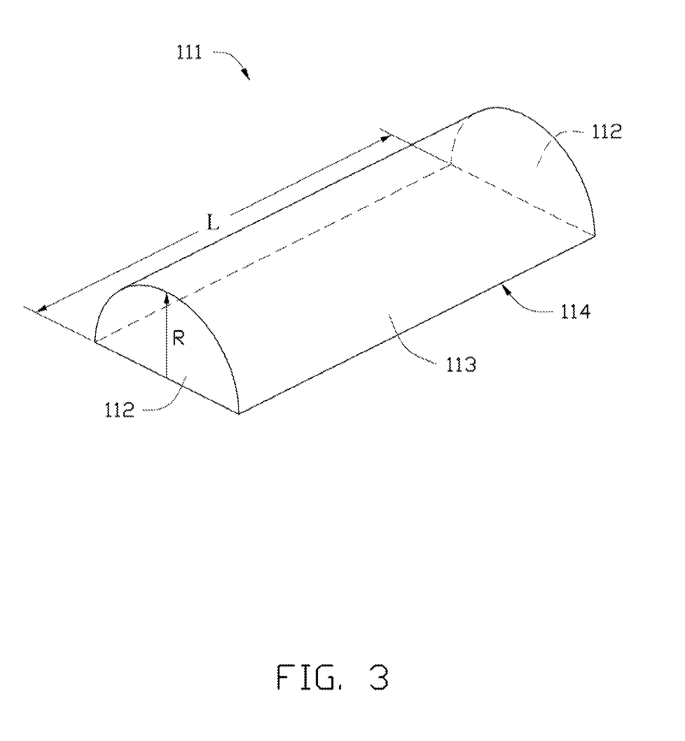

Referring to FIG. 3, the protrusions 111 are continuously distributed on the light incident surface 11. Each of the protrusions 111 is substantially semi-cylindrical, and includes two opposite semicircular end surfaces 112, an arc-shaped peripheral surface 113, and a plane-shaped fixed surface 114. The peripheral surface 113 is connected to the two end surfaces 112 and the fixed surface 114. The fixed surface 114 is opposite to the peripheral surface 113, and is perpendicular to the two end surfaces 112. The fixed surface 114 is positioned on the light incident surface 11, and a central axis of the protrusion 111 is perpendicular to the top surface 15. The length L of each protrusion 111 along its central axis is substantially equal to the thickness T of the light incident surface 11 along a direction perpendicular to the top surface 15. A radius R of each of the end surfaces 112 is more than 0 millimeters (mm) and less than 1 mm. In this embodiment, R is substantially equal to 0.04 micrometers (μm).

In use, the protrusions 111 diffuse the light rays from the light sources 20 in a way that ensure the light rays uniformly strike the light emitting area 151 such that the brightness of the light emitting area 151 becomes uniform.

It will be understood that the above particular embodiments and methods are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A light guide plate, comprising:
a main body comprising:
a light incident surface; and
a top surface perpendicular to the light incident surface, the top surface comprising:
a light emitting area; and
a fringe area surrounding the light emitting area; and
a plurality of semi-cylindrical protrusions continuously distributed on the light incident surface, each of the protrusions comprising:
two semicircular end surfaces opposite to each other;
a plane-shaped fixed surface connected to the two end surfaces and positioned on the light incident surface; and
an arc-shaped peripheral surface connected to the two end surfaces and the fixed surface;
wherein a diameter of the end surfaces is more than 0 millimeters and less than 1 millimeter, a center axis of each protrusion is perpendicular to the top surface, a length of each protrusion along its central axis is substantially equal to a thickness of the light incident surface along a direction perpendicular to the top surface.

2. The light guide plate of claim 1, wherein the fixed surface is perpendicular to the two end surfaces.

3. The light guide plate of claim 1, further comprising a bottom surface, wherein the bottom surface is opposite to the top surface and is connected to the light incident surface.

4. The light guide plate of claim 3, wherein the bottom surface is parallel to the top surface.

5. The light guide plate of claim 3, further comprising a side surface connected to the top surface and the bottom surface, the side surface opposite to the light incident surface and configured for reflecting light rays arriving thereon.

6. The light guide plate of claim 1, wherein the main body and the protrusions are made of same material.

7. The light guide plate of claim 1, wherein the main body and the protrusions are integrally formed with each other.

8. A backlight module, comprising:
a light guide plate comprising:
a main body comprising:
a light incident surface; and
a top surface perpendicular to the light incident surface, the top surface comprising:
a light emitting area; and
a fringe area surrounding the light emitting area; and
a plurality of semi-cylindrical protrusions continuously distributed on the light incident surface, each of the protrusions comprising:
two semicircular bottom surface opposite to each other;
a plane-shaped fixed surface connected to the two end surfaces and positioned on the light incident surface; and
an arc-shaped peripheral surface connected to the two end surfaces and the fixed surface;
wherein a diameter of the end surfaces is more than 0 millimeters and less than 1 millimeter, a center axis of each protrusion is perpendicular to the top surface, and a length of each protrusion along its central axis is substantially equal to a thickness of the light incident surface along a direction perpendicular to the top surface; and
a plurality of light sources facing the protrusions.

9. The backlight module of claim 8, wherein the fixed surface is perpendicular to the two end surfaces.

10. The backlight module of claim 8, further comprising a bottom surface, wherein the bottom surface is opposite to the top surface and is connected to the light incident surface.

11. The backlight module of claim 10, wherein the bottom surface is parallel to the top surface.

12. The backlight module of claim 10, further comprising a side surface connected to the top surface and the bottom surface, the side surface opposite to the light incident surface and configured for reflecting light rays arriving thereon.

13. The backlight module of claim 8, wherein the main body and the protrusions are made of same material.

14. The backlight module of claim 8, wherein the main body and the protrusions are integrally formed with each other.
